(19) United States
(12) Patent Application Publication
(10) Pub. No.: US 2005/0213605 A1
(43) Pub. Date: Sep. 29, 2005

(54) Method for efficiently utilizing radio resources in a mobile telecommunication system providing VoIP service

(75) Inventors: Soeng-Hun Kim, Suwon-si (KR); Kook-Heul Lee, Yongin-si (KR); Sung-Ho Choi, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/089,639

(22) Filed: Mar. 25, 2005

(30) Foreign Application Priority Data
Mar. 26, 2004 (KR) 2004-20804

(51) Int. Cl. H04B 7/00

(52) U.S. Cl. 370/466; 370/310

(57) ABSTRACT

A method for efficiently utilizing radio resources by reducing a size of a PDU of an RLC layer in a mobile communication system supporting a VoIP service. In the method, an RLC PDU is framed without inserting information regarding a start point and an end point of a voice packet, or existence or absence of padding, such that a size of overhead according to transmission of the voice packet can be reduced. Consequently, restricted radio resources can be efficiently used.

### PRIORITY

This application claims priority to an application entitled “Method For Efficiently Utilizing Radio Resources In Mobile Telecommunication System Providing VoIP Service” filed in the Korean Intellectual Property Office on Mar. 26, 2004 and assigned Serial No. 2004-20804, the contents of which are incorporated herein by reference.

### BACKGROUND OF THE INVENTION

1. Field of the Invention

The present invention relates to a method for efficiently utilizing radio resources by reducing a header size of a Protocol Data Unit (PDU) in a Radio Link Control (RLC) layer of a mobile communication system supporting a Voice over Internet Protocol (VoIP) service.

2. Description of the Related Art

Recently, an initial mobile communication system for providing a voice-based service, that is, voice communication, has developed into a wireless data packet communication system providing a data service and a multimedia service of a high quality at a high speed.

A Universal Mobile Telecommunication Service (UMTS) system provides a service capable of transmitting packet-based texts, digitized voice, and video and multimedia data at a high speed more than 2 Mbps regardless of a user's global position. The UMTS system is a 3G mobile communication system using a wideband Code Division Multiple Access (CDMA) based on a Global System for Mobile Communication (GSM) and a General Packet Radio Services (GPRS) used in Europe. The UMTS system as described above utilizes a connection concept of a packet switching scheme using a packet protocol such as an Internet Protocol (IP).

In relation to the packet switching scheme, the 3 Generation Partnership Project (GPP), currently in the process of standardization for the UMTS system, discusses a VoIP communication that is capable of supporting voice packets using an IP in supporting a voice service. VoIP is a communication technique for converting a voice frame generated by a voice codec into an IP/User Datagram Protocol (UDP)/Realtime Transport Protocol (RTP) packet and transmitting the packet. Accordingly, it is possible to provide a voice service through a packet network using the VoIP.

FIG. 1 is a block diagram illustrating a conventional mobile communication system providing a VoIP service, to which the present invention is applied. Referring to FIG. 1, a User Equipment (UE) 100 includes a codec 105 for converting a voice signal into a voice frame, an IP/UDP/RTP layer 104 for converting the voice frame of the codec 105 into an IP/UDP/RTP packet, a Packet Data Convergence Protocol (PDCP) layer 103 for compressing a header of the IP/UDP/RTP packet, an RLC layer 102 for converting the IP/UDP/RTP packet into packet data proper for transmission through a radio channel, and a Medium Access Control (MAC)/Physical Layer (PHY) 101 for transmitting the packet data through the radio channel.

The voice packet data transmitted from the UE 100 is forwarded to a Radio Network Controller (RNC) 120 through the radio channel via a node B 110. The RNC 120 includes an MAC/PHY 121, an RLC layer 122, and a PDCP layer 123 similarly to the UE 100. The RNC 120 converts the voice frame forwarded through the radio channel into the original IP/UDP/RTP packet and transmits the IP/UDP/RTP packet to a Core Network (CN) 130. The IP/UDP/RTP packet is transmitted to an opponent listener, i.e., a receiving UE, through an IP network 140. The receiving UE, which has the same layer structure as that of the UE 100, restores the received voice data in an order inverse to the conversion order in the UE 100, and checks the original voice signal.

Generally, the RLC layer includes an Unacknowledged Mode (UM) mode, an Acknowledged Mode (AM) mode, and a Transparent Mode (TM) mode according to an operation scheme. Herein, the VoIP operates in the RLC UM mode. The following description relates to the RLC UM mode.

An RLC UM layer of a transmission side performs division, concatenation, or padding for an RLC Service Data Unit (SDU) forwarded from an upper layer, and generates a new RLC SDU having a size proper for transmission through a radio channel. Further, the RLC UM layer generates an RLC Protocol Data Unit (PDU) for wireless channel transmission by inserting information for the division/concatenation/padding and sequence numbers into the RLC SDU. Thereafter, the RLC UM layer forwards the generated RLC PDU to a lower layer.

In response to the operation of the transmission side, an RLC UM layer of a reception side analyzes the sequence numbers and the information for the division/concatenation/padding from the RLC PDU forwarded to the lower layer, and restructures an RLC SDU. Further, the RLC UM layer forwards the restructured RLC SDU to the upper layer.

As described above, an operation enabling the RLC SDU forwarded from the upper layer to have a proper size for transmission through the radio channel will be referred to as ‘framing’.

FIG. 2A is a diagram illustrating a conventional framing operation of an RLC layer of a transmission side, to which the present invention is applied. Referring to FIG. 2A, the RLC layer 210 receives data from an upper layer 205, frames the received data to have a size proper for transmission through a radio channel, and forwards the processed data to a lower layer 215. That is, the lower layer 215 forwards the framed data to a reception side through the radio channel. Herein, the upper layer may be a PDCP layer and the lower layer may be an MAC layer. Further, the data exchanged between the RLC layer 210 and the upper layer 205 will be referred to as an ‘RLC SDU’ and the data exchanged between the RLC layer 210 and the lower layer 215 will be referred to as an ‘RLC PDU’.

FIG. 2B is a diagram illustrating a conventional framing operation of an RLC layer of a reception side, to which the present invention is applied. Referring to FIG. 2B, the RLC layer 212 restructures voice data received from a lower layer 217 into the original protocol data and forwards the protocol data to an upper layer 207. Herein, the upper layer may be a PDCP layer and the lower layer may be an MAC layer. Further, the data exchanged between the RLC layer 212 and the upper layer 207 will be referred to as an ‘RLC SDU’ and the data exchanged between the RLC layer 212 and the lower layer 217 will be referred to as an ‘RLC PDU’.

FIG. 2C is a diagram illustrating a conventional process in which the RLC layer of the transmission side generates at least one RLC PDU by framing the RLC SDU having a predetermined size according to the prior art. Referring to FIG. 2C, the RLC layer 210 receives an IP packet (i.e., RLC SDU 225) of 100 bytes from the upper layer. Herein, it is assumed that a data unit transmitted through the radio channel is set to have a size of 40 bytes. Accordingly, the RLC layer 210 frames the RLC SDU 225 of 100 bytes into three RLC PDUs 230, 235, or 240 of 40 bytes, attaches an RLC header 245 to each of the RLC PDUs 230, 235, and 240, and transmits the RLC PDUs 230, 235, and 240 through the radio channel.

The RLC header 245 includes a group including one sequence number field 250 and an E field 255, and a group including multiple Length Indicator (LI) fields 260 and an E field 265 capable of being generated according to the framing operation. Further, 7 bits of the sequence number field 250 have a value that constantly increases sequentially one by one. This represents sequences of each RLC PDU.

The E field 255 of one bit represents whether a portion after the header is constructed by a data field or a group including an LI field and an E field.

The LI field has a size of 7 or 15 bits in response to the framing operation. The LI field represents a position in which data of the RLC SDU is located in a data field of the PDU. That is, the LI field represents starting points and end points of the framed data of the RLC SDU in the RLC PDU. Further, the LI field indicates if padding exists. The value indicated by the LI field has a unit of a byte and identifies the number of bytes up to an end point of the RLC SDU in the RLC header. For convenience of description, it is assumed that the LI field has a size of 7 bits.

Referring to FIG. 2C, in the first byte of the first RLC PDU 230, a predetermined x is inserted into the sequence number field and ‘1’ is inserted into the first E field in order to represent that the next byte includes a pair of an LI field and an E field. Wherein, the x indicates a size of a random RLC PDU. In the second byte of the RLC PDU 230, the LI field represents that the first byte of the data field in the RLC PDU 230 is identical to the starting point of the RLC SDU. Further, ‘1111 100’ may be inserted into the LI field. ‘0’ is inserted into the second E field, which represents that the next byte is the data field. Accordingly, the first 38 bytes of the RLC SDU are inserted into the data field of 38 bytes obtained by subtracting the two bytes from the RLC PDU 230 of 40 bytes.

In the first byte of the second RLC PDU 235, a predetermined (x+1) is inserted into the sequence number field and ‘0’ is inserted into the first E field, which represents that the next byte is a data field. This represents that the second byte of the second RLC PDU 235 does not separately require an LI field because the second RLC PDU 235 does not include the last byte of the RLC SDU. Accordingly, the next data of the RLC SDU, i.e., the total 39 bytes from a 39^{th} byte, is inserted into the data field of remaining 39 bytes of the RLC PDU 235.

In the first byte of the third RLC PDU 240, a predetermined (x+2) is inserted into the sequence number field and ‘1’ is inserted into the first E field, which represents that the next byte includes a pair of an LI field and an E field. In the second byte of the RLC PDU 240, ‘0010 111 (=23)’ is inserted into an LI field, which represents that the last byte of the RLC SDU is a 23^{rd} byte of a data field. Further, ‘1’ is inserted into the second E field. Herein, the data field of the RLC PDU 240 includes a surplus corresponding to the RLC SDU 225 of the total 100 bytes. Accordingly, the second E field is set to 1 in order to report that the extra data field of the RLC PDU 240 is subjected to padding. That is, ‘1111 111’ is inserted into the second LI field, which reports the padding for the extra data field. ‘0’ is inserted into the third E field. Accordingly, the data field of the RLC PDU 240 is filled with the last 23 bytes of the RLC SDU and remaining 14 bytes are subjected to padding.

The reception side receives the RLC PDUs and sequentially arranges the RLC PDUs based on the sequence numbers of the RLC PDUs. That is, the reception side recognizes that the data field of the first RLC PDU 230 corresponds to the first portion of the RLC SDU through the LI of the first RLC PDU 230. Further, the reception side recognizes that the data field of the second RLC PDU 235 corresponds to the second portion of the RLC SDU through the LI of the first RLC PDU 230 and the RLC SDU has not been completely restructured. The reception side recognizes that 23 bytes of the data field of the third RLC PDU 240 corresponds to the last portion of the RLC SDU through the first LI field of the third RLC PDU 240 and completes the restructuring of the RLC SDU.

Further, the reception side recognizes that a remaining portion of the data field of the third RLC PDU 240 is subjected to padding through the second LI field of the third RLC PDU 240.

As described above, the scheme for indicating the location of the last byte of the RLC SDU using the LI field is efficient when an RLC SDU is divided into a plurality of RLC PDUs or when a plurality of RLC SDUs are concatenated to one RLC PDU.

As described above, the RLC layer of the transmission side restructures the RLC SDU having a predetermined size into at least one RLC PDU for transmission through the radio channel, and inserts the sequence number and the LI regarding the division/concatenation/padding according to the restructuring into the RLC header, thereby enabling the RLC layer of the reception side to restructure the RLC PDUs into the RLC SDU.

Hereinafter, characteristics of the packet generating in the VoIP communication will be briefly described. A 12.2 kbps Adaptive Multi-Rate (AMR) codec widely used in the 3GPP is used by way of example.

The AMR codec generates a voice frame of 7 or 32 bytes each 20 msec. The voice frame is encapsulated with an IP/UDP/RTP header and forwarded to an RLC layer after a header compression in a PDCP layer. The compressed header typically has a size of one byte and rarely may have a size of 2 to 10 bytes.

The RLC SDU has a size of 8 to 18 bytes and 33 to 43 bytes. That is, the RLC SDU having the size is forwarded to an RLC layer of a transmission side each 20 msec. The RLC layer restructures one RLC SDU into one RLC PDU and transmits the RLC PDU through a radio channel. Herein, the RLC SDU having the size of 8 or 33 bytes is most frequently generated.

Consequently, the size of the RLC PDU must be determined in such a manner that the RLC SDU most frequently generated can be efficiently processed.

Accordingly, if an RLC framing operation is continued, the RLC PDU may obtain the most efficient size by adding an UMD PDU header of one byte and by adding an LI and an E of two bytes to the size of the RLC SDU most frequently generated.

Further, in order to support the RLC SDU of remaining sizes, a plurality of sizes of the RLC PDU must be further defined. For example, the RLC PDU of 11 and 36 bytes is defined for the RLC SDU of 8 and 33 bytes. Further, the RLC PDU of 21 and 46 bytes may be defined for the RLC SDU of the remaining sizes.

FIGS. 3 and 4 are diagrams illustrating a conventional RLC SDU using an existing framing scheme. More specifically, FIG. 3 illustrates an RLC SDU corresponding to a data field of an RLC PDU.

Referring to FIG. 3, when the RLC SDU has a size of 8 or 33 bytes, the RLC PDU is framed after an RLC header of 3 bytes is appended to the RLC SDU. Herein, LIs of 2 bytes are actually meaningless information. That is, when one RLC SDU corresponds to the data field of the RLC PDU, without passing through the division/concatenation/padding, it is unnecessary to indicate a starting point and an end point of the RLC SDU through the LI. However, in the prior art, because the data field of the RLC PDU is a random portion of an RLC SDU when the LI is not used, it is necessary to insert the LI for indicating the starting point and the end point.

FIG. 4 illustrates an RLC SDU performing a padding for a portion of a data field of an RLC PDU using a packet smaller than the data field. That is, when the RLC SDU does not coincide with the data field, a framing scheme is employed, which uses an LI representing a starting point of the RLC SDU, an LI representing an end point of the RLC SDU, and an LI representing the use or non-use of a padding.

For example, an RLC SDU of 14 bytes is framed into an RLC PDU of 21 bytes. A header of the total 4 bytes is appended to the RLC PDU, which includes a pair of a sequence number field representing an order of the RLC SDU and an E field, an LI representing a starting point of the RLC SDU, an LI representing an end point of the RLC SDU, and an LI representing use or non-use of a padding.

As described above, in a VoIP communication, packet data must be processed in real-time, in contrast with general packet communication, and an RLC SDU is generated in each a predetermined period.

More specifically, in the VoIP communication, the RLC SDU is not divided or concatenated. Instead, one RLC SDU is formed into one RLC PDU. Nevertheless, when the existing framing operation for the RLC is used as is as described above, two or more LIs are always inserted into the RLC PDU. That is, it is necessary to insert the LI representing the starting point of the RLC SDU and the LI representing the end point of the RLC SDU into the RLC PDU. As the situation requires, the LI indicating the use or non-use of the padding in the data field may be inserted into the RLC PDU.

Accordingly, when the existing RLC PDU framing scheme is used in the VoIP communication, the LI fields must be continuously added. Therefore, radio resources are inefficiently used.

### SUMMARY OF THE INVENTION

Accordingly, the present invention has been designed to solve the above and other problems occurring in the prior art. It is an object of the present invention to provide a method for efficiently using radio resources by an RLC layer in a mobile communication system providing a VoIP service.

It is another object of the present invention to provide a method for forming a frame according to a voice packet by an RLC layer in a mobile communication system providing a VoIP service.

It is further another object of the present invention to provide a method for efficiently forming a voice packet unit by an RLC layer in a mobile communication system providing a voice packet.

It is still another object of the present invention to provide a method for efficiently using radio resources by an RLC layer, thereby reducing overhead added in order to transmit a voice packet in a mobile communication system.

In accordance with one aspect of the present invention, there is provided a method for generating a Protocol Data Unit (PDU) by a Radio Link Control (RLC) layer using a Service Data Unit (SDU) received from an upper layer in a mobile communication system supporting a Voice over Internet Protocol (VoIP) service. The method includes the steps of: checking, by the RLC layer, if a size of the received SDU is identical to a size of a data field of the PDU; framing a header including information representing that the size of the SDU is identical to the size of the data field of the PDU; and generating the PDU by allocating the SDU to the data field of the PDU.

In accordance with another aspect of the present invention, there is provided a method for extracting a Service Data Unit (SDU) by a Radio Link Control (RLC) layer of a reception side using a Protocol Data Unit (PDU) received from an RLC layer of a transmission side in a mobile communication system supporting a Voice over Internet Protocol (VoIP) service. The method includes the steps of: receiving the PDU from a lower layer; checking information from a header of the PDU, the information representing that a size of a data field of the PDU is identical to a size of the SDU; and extracting an entire data field of the PDU as the SDU when the information has been set to have an equal value.

In accordance with further another aspect of the present invention, there is provided a method for generating a Protocol Data Unit (PDU) by a Radio Link Control (RLC) layer using a Service Data Unit (SDU) received from an upper layer in a mobile communication system supporting a Voice over Internet Protocol (VoIP) service. The method includes the steps of: receiving, by the RLC layer, a dedicated SDU from the upper layer; checking if a size of the received SDU is identical to a size of the dedicated SDU; and allocating the SDU to a data field of the PDU, when the size of the received SDU is identical to the size of the dedicated SDU.

In accordance with still another aspect of the present invention, there is provided a method for extracting a Service Data Unit (SDU) by a Radio Link Control (RLC) layer of a reception side using a Protocol Data Unit (PDU) received from an RLC layer of a transmission side in a mobile communication system supporting a Voice over Internet Protocol (VoIP) service. The method includes the steps of: receiving, by the RLC layer, the PDU from a lower layer; checking if a size of a data field of a PDU previously received from an upper layer is identical to a size of a data field of the received PDU; and extracting an entire data field of the PDU as the SDU, when the size of the data field of the previously received PDU is identical to the size of the data field of the received PDU.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram illustrating a mobile communication system providing a VoIP service, to which the present invention is applied;

FIGS. 2A and 2B are diagrams illustrating framing operations of RLC layers in a transmission/reception side, to which the present invention is applied;

FIG. 2C is a diagram illustrating an RLC PDU according to the prior art;

FIG. 3 is a diagram illustrating an RLC SDU using an existing framing scheme;

FIG. 4 is a diagram illustrating an RLC SDU using an existing framing scheme;

FIG. 5 is a diagram illustrating an RLC PDU according to a framing scheme proposed by the present invention;

FIG. 6A is a diagram illustrating an RLC PDU according to an embodiment of the present invention;

FIG. 6A is a diagram showing the structure of an RLC PDU according to an embodiment of the present invention;

FIG. 7 is a flow diagram illustrating an operation for transmitting an RLC PDU by an RLC layer according to an embodiment of the present invention;

FIG. 8 is a flow diagram illustrating an operation for receiving an RLC PDU by an RLC layer according to an embodiment of the present invention;

FIG. 9 is a flow diagram illustrating an operation for transmitting an RLC PDU by an RLC layer according to an embodiment of the present invention;

FIG. 10 is a flow diagram illustrating an operation for receiving an RLC PDU by an RLC layer according to an embodiment of the present invention;

FIG. 11 is a flow diagram illustrating an operation of an RLC layer according to an embodiment of the present invention; and

FIG. 12 is a flow diagram illustrating an operation of an MAC layer according to an embodiment of the present invention.

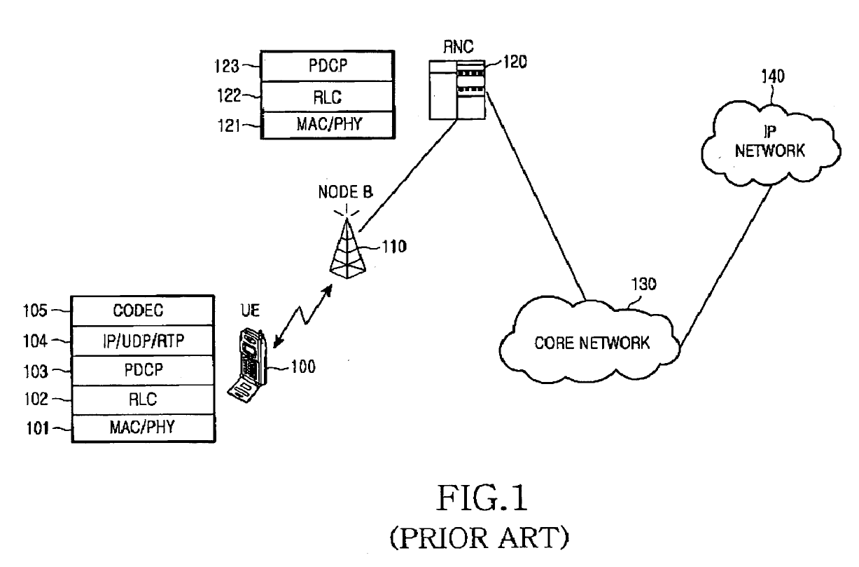

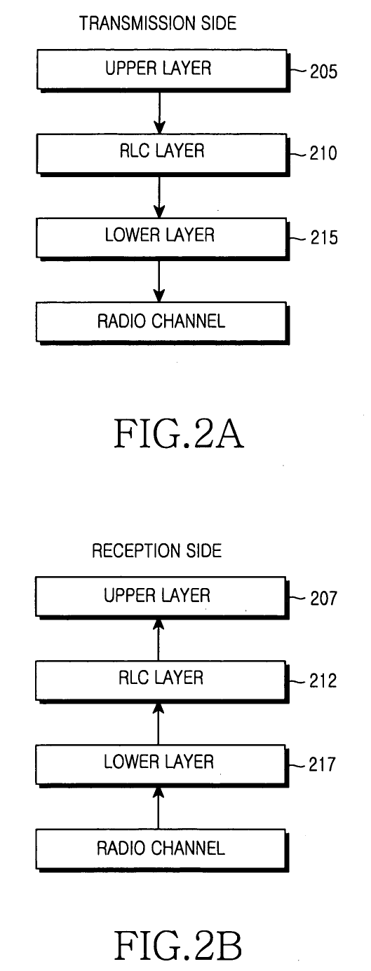

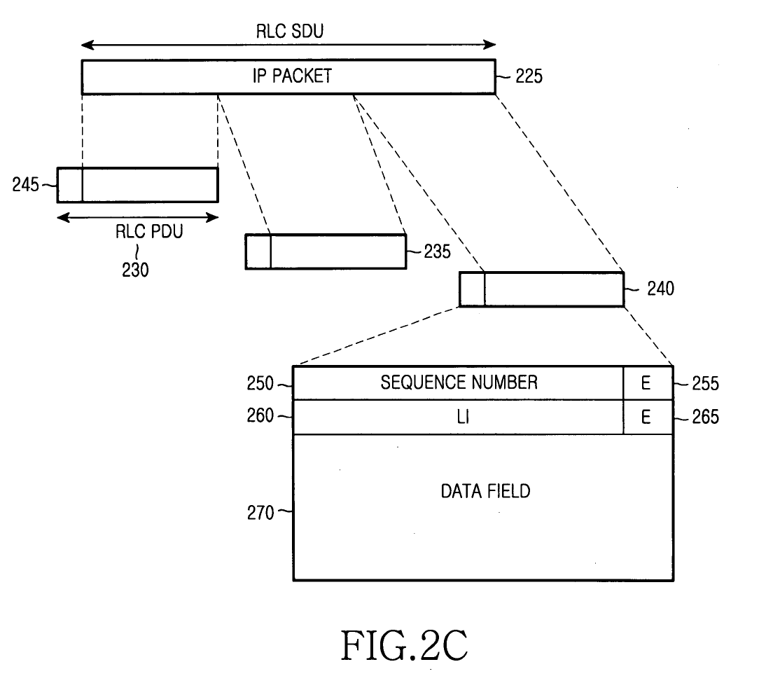

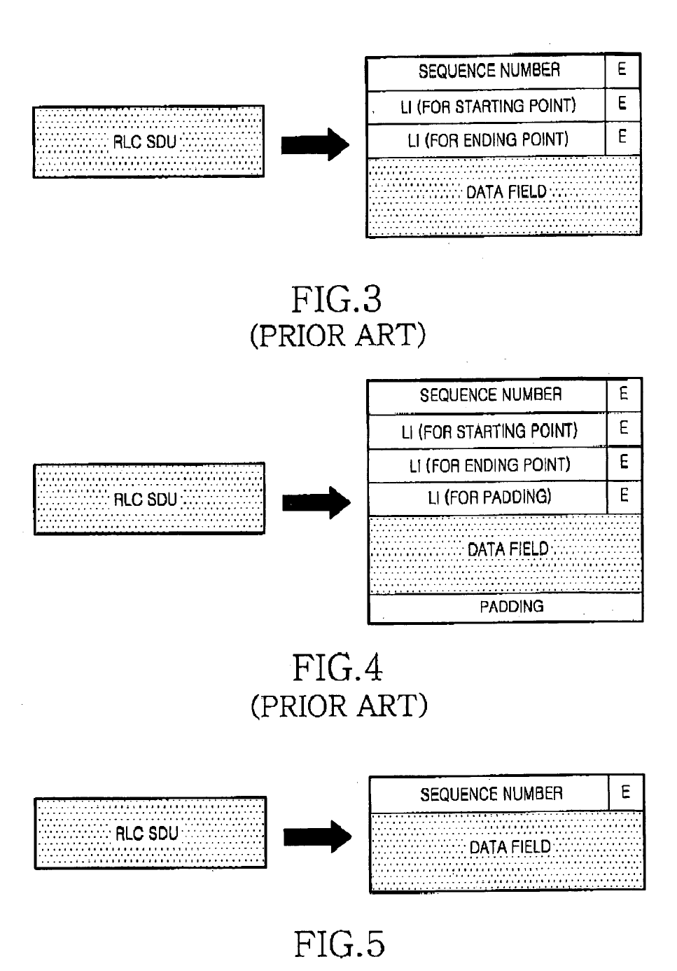

### DETAILED DESCRIPTION OF THE PREFERRED EMBODIMENT

Preferred embodiments according to the present invention will be described in detail herein below with reference to the accompanying drawings. In the following description of the present invention, a detailed description of known functions and configuration incorporated herein will be omitted when it may make the subject matter of the present invention rather unclear. Further, the terms in the specification must be defined on the basis of the entire contents of the specification.

The present invention is directed to a method for forming a frame according to a voice packet by an RLC layer in a mobile communication system providing a VoIP service. Herein, for convenience of description, a sequence number field and a first E field of a frame RLC PDU according to the voice packet will be referred to as an Unacknowledged Mode Data (UMD) PDU header. Further, the UMD PDU header and an LI field and a second E field will be referred to as an RLC header. That is, remaining portions excluding a data field from an RLC PDU correspond to the RLC header.

FIG. 5 is a diagram illustrating an RLC PDU according to a framing scheme proposed by the present invention. Referring to FIG. 5, framing is performed for RLC PDUs having sizes most frequently used without using an LI. Herein, the following two framing schemes may be used:
1) framing not using the LI is used when a division/concatenation/padding is not required because the RLC SDU is the same size as the data field of the RLC PDU; and
2) framing using the LI is used when a division/concatenation/padding is required because the RLC SDU is different a size different than the data field of the RLC PDU.

Accordingly, different framing schemes may be applied to each voice packet. Herein, a transmission side must inform a reception side of a framing scheme applied to a predetermined packet.

As described above, when an RLC SDU is the same size as a data field of an RLC PDU, the use of the LI wastes limited resources. Accordingly, the present invention does not use the LI when the LI is not required. That is, when a division/concatenation/padding has not been used because the RLC SDU exactly corresponds to the data field of the RLC PDU, the LI is not used. In addition, the fact that the RLC SDU has exactly corresponded to the data field of the RLC PDU is indicated.

In relation to the aforementioned description, an embodiment of the present invention adds a new field, that is, Segmentation Indication (SI) information, to a header of a UMD PDU. That is, an RLC layer clearly indicates if the LI is used by newly adding the SI information to an RLC header.

Further, another embodiment of the present invention presets a size of a random RLC SDU not using the LI and enables the use or non-use of the LI to be analogized through the size of the RLC SDU.

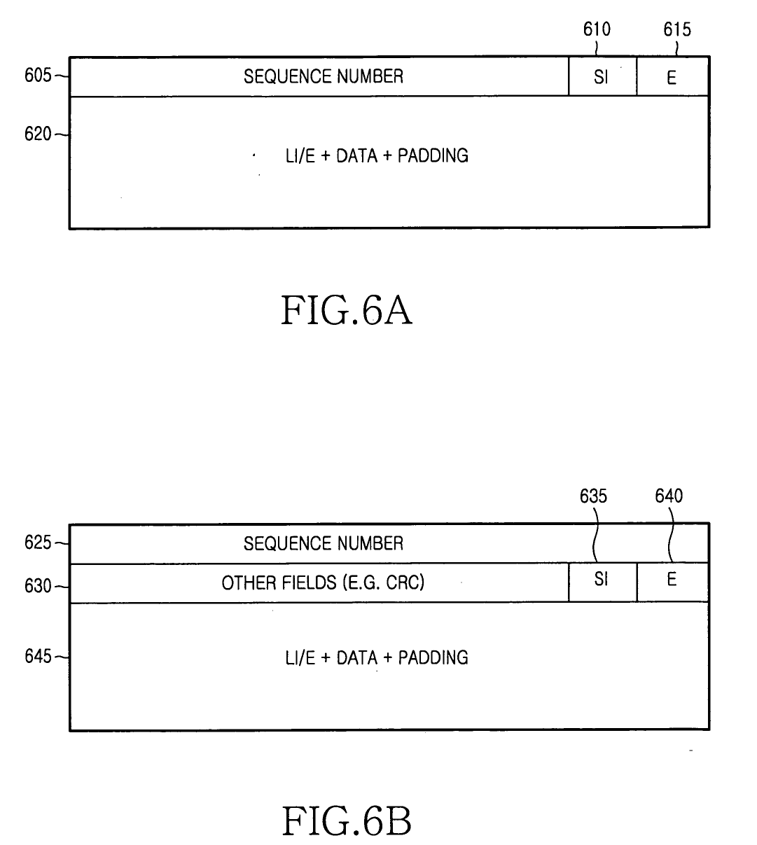

FIG. 6A is a diagram illustrating an RLC PDU according to an embodiment of the present invention. Referring to FIG. 6A, the RLC PDU includes an RLC header, which contains a sequence number field 605 of 6 bits, an SI field 610 of one bit, an E field 615 of one bit, and a remaining portion 620. Herein, the remaining portion 620 may include an LI field, an E field, a data field, and padding according to values of the field 615. That is, the RLC header according to the present invention uses one bit of the sequence number field in the existing UMD PDU header as the SI field. The SI field 610 indicates that the RLC SDU has a size that is identical to that of the data field of the RLC PDU according to the definition of the present invention.

The sequence number field has a value that continually increases one by one for each RLC PDU. A sequence number is inserted into the sequence number field. Accordingly, a reception side may understand an order of received RLC PDUs. The E field may be set to 0 or 1, which indicates whether the next byte is constructed by an LI field and an E field, or a data field.

The SI field 610 may be set to 0 or 1. Herein, setting the SI field 610 to 0 indicates that one RLC SDU exactly corresponds to a data field of one RLC PDU. Accordingly, this means that the LI is not used to indicate a start and an end of the RLC SDU.

In contrast, setting the SI field 610 to 1 indicates that an RLC SDU does not correspond to the data field of an RLC PDU. Accordingly, this means that the LI is used to indicate a start and an end of the RLC SDU.

FIG. 6B is a diagram illustrating an RLC PDU according to an embodiment of the present invention. As indicated above, the present invention indicates use or non-use of the LI by using an SI bit. Accordingly, a detailed location of the SI bit in the header field is a secondary matter. Herein, because it may be difficult to reduce the number of bits of the sequence number field to be six bits as illustrated in FIG. 6A, it may be assumed that it is possible to increase the size of the UMD PDU header to be two bytes as illustrated in FIG. 6B.

Referring to FIG. 6B, the size of the UMD PDU header increases from the existing one byte to two bytes. Herein, an SI field is inserted into the increased header, which indicates that the RLC SDU has a size identical to that of the data field of the RLC PDU.

Generally, it is preferred that a header has a smaller size. However, in order to efficiently support a VoIP service, the existing UMD PDU header is adjusted for use. For example, in order to use voice data including an error, it may be necessary to insert a separate CRC into an RLC header. If the size of the UMD header increases by another requirement like this, a predetermined one bit of the increased header may be used as the SI field.

That is, the RLC PDU may include a sequence number field 625 of 8 bits, other fields 630 of 6 bits, an SI field 635 of one bit, an E field 640 of one bit, and a remaining portion 645. The other fields 630 of 6 bits may include a CRC result value calculated for the RLC header. Further, the remaining portion 645 may include an LI filed, an E bit, a data field, and padding according to values of the E field 640.

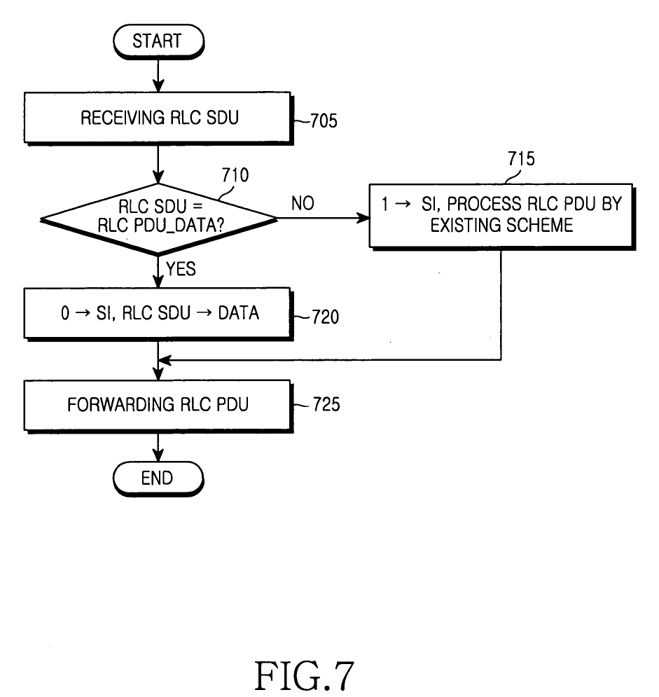

FIG. 7 is a flow diagram illustrating an operation for transmitting the RLC PDU by an RLC layer of a transmission side according to an embodiment of the present invention. Referring to FIG. 7, the RLC layer receives the RLC SDU from an upper layer in step 705, and determines if the received RLC SDU has a size coinciding with one of sizes of the data field in the RLC PDU in step 710.

Herein, the size of the data field in the RLC PDU may be calculated by Equation (1).
RLC PDU_Data size=RLC PDU size−K,
K=(UMD header size+Special LI size) (1)

Herein, a plurality of available RLC PDU sizes may exist in the RLC UM mode. Accordingly, the RLC PDU_Data size is calculated for each RLC PDU size and a plurality of the RLC PDU_Data sizes may also exist.

In relation to the K value, the UMD header size has fixed values, i.e., one byte in FIG. 6A and two bytes in FIG. 6B. Further, the Special LI is a kind of an LI used for a special purpose. This represents that an end of a previous RLC PDU exactly coincides with an end of an RLC SDU. That is, because the end of the previous RLC PDU exactly coincides with the end of the RLC SDU in the previous RLC PDU, the Special LI is used when an LI for representing the end point is not contained. In such a case, the RLC transmission side inserts an LI having been set to ‘0000 000’ into the next RLC PDU. Accordingly, when it is necessary to use the Special LI according to the occurrence of the aforementioned situation at a corresponding time point, the Special LI size is one byte. However, when it is not necessary to use the Special LI, the Special LI size is zero bytes.

For example, it is assumed that a random RLC SDU is being transmitted after being divided into a plurality of portions and the last portion has a size of 20 bytes.

Herein, if the RLC PDU has a size of 21 bytes, the RLC PDU of 21 bytes is constructed by a UMD PDU header of one byte and the last portion of 20 bytes in the RLC SDU. Accordingly, the LI cannot be inserted into the RLC PDU. Herein, the Special LI set to ‘0000 000’ is inserted into the next RLC PDU.

In step 710, the RLC layer determines if the RLC SDU has a size coinciding with one of the available RLC PDU_Data sizes. When the RLC SDU has the size coinciding with one of the available RLC PDU_Data sizes, step 720 is performed. However, if the RLC SDU does not have the size coinciding with one of the available RLC PDU_Data sizes, step 715 is performed.

In step 715, the RLC layer sets the SI to 1 and frames the RLC SDU into the RLC PDU according to the existing scheme. That is, the RLC layer inserts a proper value into a sequence number field. As the situation requires, the RLC layer may perform an concatenation/division for the RLC SDU. Further, the RLC layer inserts an LI field in order to indicate a starting point and an end point of the RLC SDU. When a data field has an extra, the RLC layer may insert a padding. The RLC layer also inserts the RLC SDU into the data field, thereby completing the framing of the RLC PDU.

When the RLC SDU has the size coinciding with one of the available RLC PDU_Data sizes, in step 720, the RLC layer sets the SI to 0 and inserts the RLC SDU into the data field of the RLC PDU so as to form the RLC PDU. As the situation requires, the Special LI having been set to ‘0000 000’ may be inserted. However, an LI field indicating the start and the end of the RLC SDU is not used.

In step 725, the RLC layer forwards the completed RLC PDU to a lower layer, and then returns to step 705. That is, the RLC layer waits for the next RLC SDU.

In the embodiment described above, it is possible to form the RLC PDU more efficiently by using the SI value representing that an RLC SDU exactly corresponds to the data field of an RLC PDU.

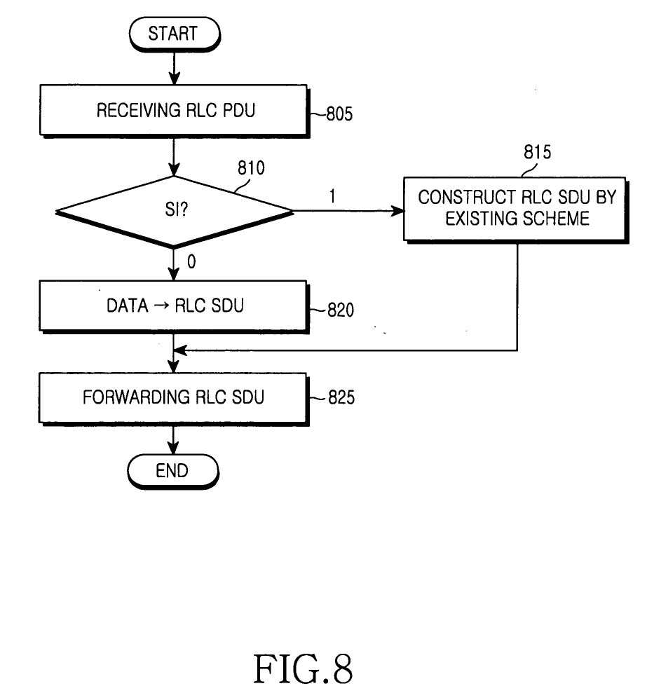

FIG. 8 is a flow diagram illustrating an operation of an RLC layer of a reception side according to an embodiment of the present invention. Referring to FIG. 8, the RLC layer receives the RLC PDU from a lower layer in step 805, and inspects the SI field of the received RLC PDU in step 810. If the SI has a value of 1, step 815 is performed. However, if the SI has a value of 0, step 820 is performed.

In step 815, the RLC layer frames the received RLC PDU into an RLC SDU according to the existing scheme. That is, the RLC layer identifies the starting point and the end point of the RLC SDU through the LI field according to the existing scheme and extracts the RLC SDU from the data field of the RLC PDU.

In step 820, the RLC layer frames the entire data field of the RLC PDU into the RLC SDU. That is, the RLC layer frames portions remaining after removing the UMD header of the received RLC PDU into the RLC SDU. Herein, when the LI field having a value of ‘0000 000’ has been used, the RLC layer frames portions remaining after removing the LI field into the RLC SDU.

In step 825, the RLC layer forwards the RLC SDUs framed in steps 815 and 820 to an upper layer. Thereafter, the procedure returns to step 805, i.e., the RLC layer waits for the next RLC PDU.

Herein, because the present invention supports the VoIP service, the UE and the RNC include forward and backward RLC layers, respectively. That is, the UE includes the RLC layer for receiving data forward and the RLC layer for transmitting data backward. Further, the RNC also includes the RLC layer for transmitting data forward and the RLC layer for receiving data backward. Hereinafter, the above-described embodiment of the present invention is described below with an example in which the RLC PDU size is 9, 22, 34, or 46 bytes.

It is assumed that the RLC layer of the UE receives an RLC SDU of 10 bytes from an upper layer at one predetermined point of time and it is not necessary to transmit the special LI having a value of ‘0000 000’. Accordingly, the RLC PDU_Data size may be calculated by Equation (2).

$$\begin{matrix}RLC PDU\_Data size = RLC PDU size - 1 \\ = 8 , 21 , 33 , 45\end{matrix} \qquad ( 2 )$$

That is, the RLC PDU_Data size is 8, 21, 33 or 45 bytes.

Herein, when there are no the RLC PDU_Data sizes coinciding with the RLC SDU size, the RLC layer of the UE set the SI field to 1 and frames an RLC PDU according to the existing scheme.

Accordingly, the RLC layer selects the RLC PDU size of 22 bytes so that the RLC SDU can be transmitted without being divided. Further, the RLC layer inserts a proper sequence number into a sequence number field, sets the SI field to 1 in order to indicate that data sizes of the RLC SDU and the RLC PDU do not coincide with each other, and sets a first E field to 1. Further, the RLC layer sets a first LI field to ‘1111 100’ and sets a second E field to 1. Accordingly, the RLC layer indicates a starting point of the RLC SDU.

In addition, the RLC layer sets a second LI field to ‘0001 010’ and sets a third E field to 1. Accordingly, the RLC layer indicates an end point of the RLC SDU. Moreover, the RLC layer sets a third LI field to ‘1111 111’ and sets a fourth E field to 0. Accordingly, the RLC layer indicates that a remaining portion is padding.

When the framing of the RLC header is completed by the method as described above, the RLC layer completes the framing of the RLC PDU by inserting an RLC SDU into an RLC data field and filling a remaining portion with padding, and transmits the RLC PDU.

Accordingly, the reception side receives the RLC PDU, determines if the SI field of the RLC header is 1, analyzes the LI field, and extracts the RLC SDU. That is, because the SI field is set to 1, the reception side recognizes that the first byte of the RLC SDU is the first byte of the data field of the RLC PDU through the first LI field, recognizes that the last byte of the RLC SDU is the 10^{th} byte of the data field of the RLC PDU through the second LI field, and recognizes that a remaining portion of the data field of the RLC PDU is the padding through the third LI field.

It is assumed that the RLC layer of the UE receives an RLC SDU of 8 bytes from the upper layer at another predetermined point of time and it is not necessary to transmit the special LI having a value of ‘0000 000’.

Because the received RLC SDU has a size coinciding with one of the RLC PDU_Data sizes, the RLC layer of the UE operates as described below. That is, the RLC layer selects the RLC PDU size of 9 bytes in order to maximize transmission efficiency, inserts a sequence number into a sequence number field, and sets the SI field to 0. Herein, because it is unnecessary to transmit the special LI having a value of ‘0000 000’, the RLC layer sets the first E field to 0. Accordingly, the RLC layer completes the framing of the RLC header.

Thereafter, the RLC layer completes the framing of the RLC PDU by inserting an RLC SDU into the data field of the RLC PDU, and forwards the RLC PDU.

If the RLC PDU is received, the reception side checks that the SI is zero and recognizes that the data field of the RLC PDU exactly coincides with one RLC SDU. Further, the reception side recognizes 8 bytes corresponding to the data field as an RLC SDU and forwards the RLC SDU to the upper layer.

In the VoIP communication system, the RLC SDU has variable sizes, but a specific size of the RLC SDU is frequently used. In an example of an AMR voice codec, an AMR codec generates a voice frame of 7 or 32 bytes each 20 msec. The voice frame is encapsulated with an IP/UDP/RTP header, is subjected to a header compression process, and is transferred to an RLC layer. The compressed header typically has a size of one byte and may also have a size of about 10 bytes as the situation requires.

When considering operation environments of the VoIP communication, the RLC SDUs of 8 to 18 bytes and 33 to 43 bytes are transferred from an upper layer to an RLC layer. From among the RLC SDUs, the RLC SDU of 8 or 33 bytes are most frequently transferred.

In an embodiment of the present invention, the RLC PDU size is set to enable an RLC SDU having a size most frequently occurring to exactly coincide with the data field of the RLC PDU, and the LI field representing the starting point and the end point of the RLC SDU is not used in the RLC PDU. Accordingly, the RLC layer of the transmission side and the RLC layer of the reception side must recognize in advance the size of the RLC SDU for which the LI field is to be omitted.

That is, the RLC layer of the transmission side and the RLC layer of the reception side manage the size of the RLC SDU using a Special_RLC_SDU_SIZE parameter. The Special_RLC_SDU_SIZE may be transferred from an upper control layer in a call setup process.

That is, when the RLC SDU received from an upper layer has the same size as the Special_RLC_SDU_SIZE, the RLC layer of the transmission side does not use the LI field according to a division/concatenation/padding for the RLC SDU. Herein, the sizes of RLC SDU, which most frequently occur in the VoIP communication, will be referred to as the Special_RLC_SDU_SIZE.

When the data field of the RLC PDU received from a lower layer has the same size as the Special_RLC_SDU_SIZE, the RLC layer of the reception side regards the entire data field of the RLC PDU as one RLC SDU.

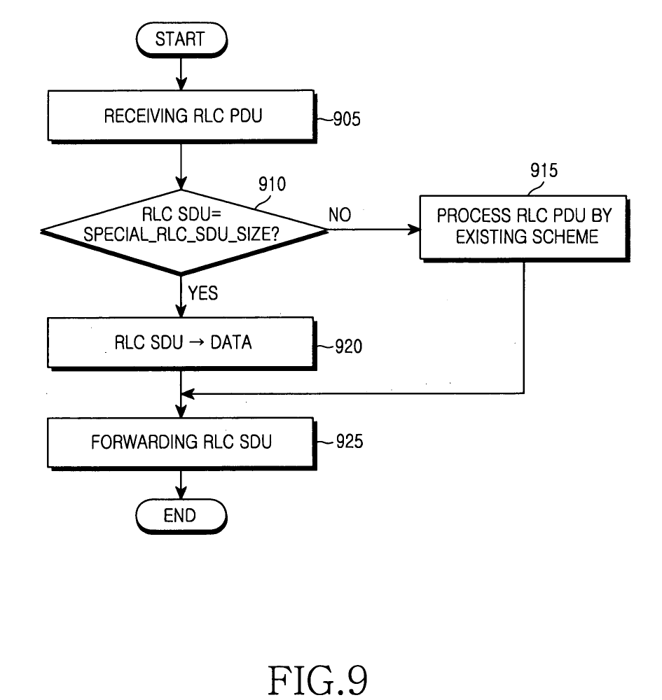

FIG. 9 is a flow diagram illustrating an operation for transmitting an RLC PDU by an RLC layer according to an embodiment of the present invention. Referring to FIG. 9, the RLC layer of the transmission side receives the RLC SDU from an upper layer in step 905. Herein, the RLC layer of the transmission side has already received information for the Special_RLC_SDU_SIZE from the upper control layer. Further, the RLC SDU size larger than the Special_RLC_SDU_SIZE by one byte has been already framed. The RLC SDU size may be optionally set by the upper control layer.

In step 910, the RLC layer determines if the received RLC SDU has a size coinciding with one of the Special_RLC_SDU_SIZE. When the RLC SDU has the size coinciding with one of the Special_RLC_SDU_SIZE, step 920 is performed. However, when the RLC SDU has the size coinciding with one of the Special_RLC_SDU_SIZE, step 915 is performed.

In step 915, the RLC layer frames the RLC SDU into the RLC PDU according to the existing scheme. That is, the RLC layer inserts a sequence number having a proper value. As the situation requires, the RLC layer may perform a concatenation/division for the RLC SDU and inserts an LI field in order to indicate a starting point and an end point of the RLC SDU. If padding has been used, the RLC layer inserts an LI field reporting the padding and inserts the RLC SDU into the data field, thereby completing the framing of the RLC PDU.

In step 920, the RLC layer inserts a sequence number having a proper value, inserts the RLC SDU into the data field, thereby framing the RLC PDU. In step 920, the concatenation/division/padding is not performed and the data field of the RLC PDU exactly coincides with the RLC SDU. That is, when the Special_RLC_SDU_SIZE is used for the RLC SDU having a high frequency, a separate LI field according to the concatenation/division/padding is not used for the RLC SDU.

In step 925, the RLC layer forwards the completed RLC PDU to a lower layer. Thereafter, the procedure returns to step 905 i.e., the RLC layer waits for the next RLC SDU.

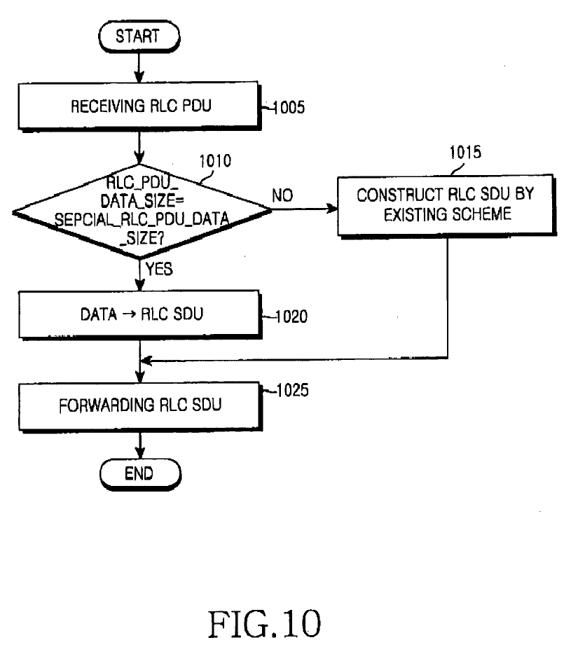

FIG. 10 is a flow diagram illustrating an operation for receiving an RLC PDU by an RLC layer according to an embodiment of the present invention. Referring to FIG. 10, the RLC layer of the reception side has already received information for the Special_RLC_SDU_SIZE from the upper control layer.

In step 1005, the RLC layer receives the RLC PDU from a lower layer. In step 1010, the RLC layer compares the size of the data field of the RLC PDU (i.e., RLC PDU_Data size) with the Special_RLC_SDU_SIZE. If the size of the data field of the RLC PDU coincides with one of the Special_RLC_SDU_SIZE, step 1020 is performed. However, if the size of the data field of the RLC PDU does not coincide with one of the Special_RLC_SDU_SIZE, step 1015 is performed.

In step 1015, the RLC layer uses the existing scheme in framing the received RLC PDU into an RLC SDU. That is, the RLC layer analyzes the LI field, identifies a starting point and an end point of the RLC SDU, and extracts the RLC SDU from the data field.

In step 1020, the RLC layer frames the entire data field of the RLC PDU into the RLC SDU. That is, the RLC layer removes a UMD header of the received RLC PDU. Herein, when the LI field having been set to ‘0000 000’ has been used, the RLC layer regards a remaining portion after removing the LI field as the RLC SDU.

In step 1025, the RLC layer forwards the RLC PDUs framed in steps 1015 and 1020 to an upper layer. Thereafter, the procedure returns to step 1005 i.e., the RLC layer waits for the next RLC PDU.

In the above-described embodiments of the present invention, the RLC layer determines the size of the RLC PDU. The size of the RLC PDU may also be determined by an MAC layer. In such a case, operations of the RLC layer and the MAC layer will be described herein below in another embodiment.

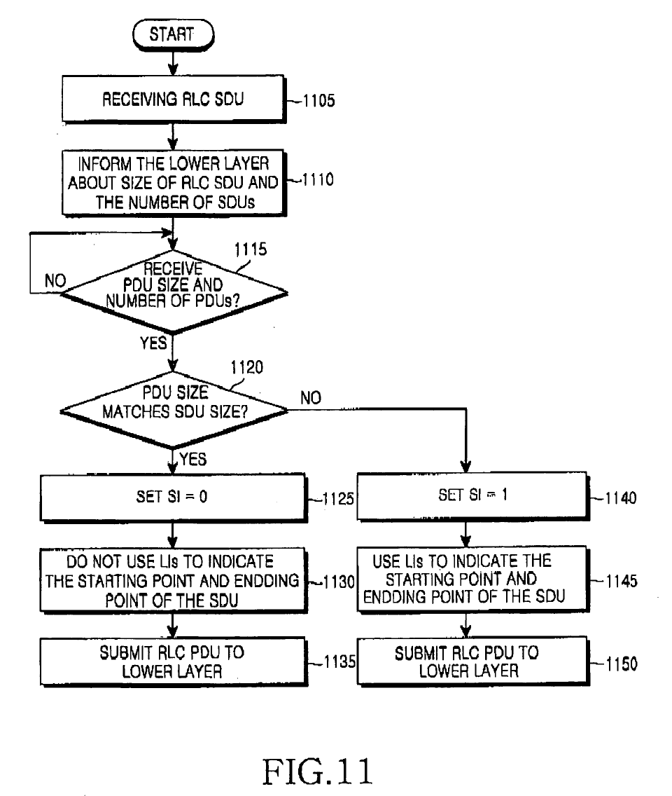

FIG. 11 is a flow diagram illustrating an operation of an RLC transmission side according to another embodiment of the present invention. Referring to FIG. 11, when the RLC SDUs are received from an upper layer in step 1105, the RLC transmission side informs a lower layer of the sizes and the number of the received RLC SDUs in step 1110. The lower layer may be the MAC layer. When it is necessary to transmit the LI field having been set to ‘0000 000’ in transmitting the RLC SDU, the RLC transmission side informs the lower layer of a value obtained by adding one byte to the size of the RLC SDU.

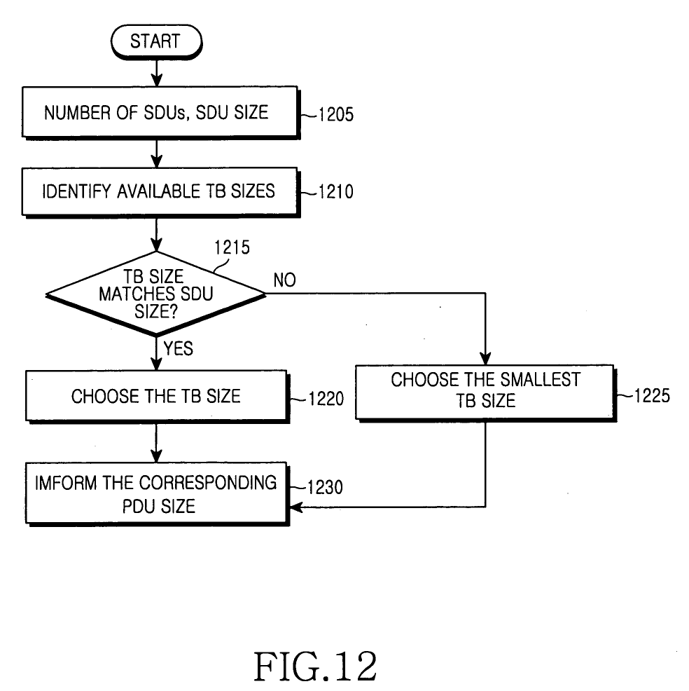

In step 1115, the RLC transmission side waits until the lower layer notifies the sizes and the number of RLC PDUs to be used in the next transmission interval. That is, the lower layer determines the most efficient size of the RLC PDU using information received from the RLC layer in step 1110, and notifies the RLC transmission side of the determined size in step 1115. After the RLC transmission side has received the sizes and the number of RLC PDUs to be used in the next transmission interval in step 1115, step 1120 is performed. The operation of the lower layer will be described in more detail later with reference to FIG. 12.

In step 1120, the RLC transmission side determines if the size of the RLC PDU received from the lower layer coincides with the size of the RLC SDU received from the upper layer. If the size of the RLC PDU coincides with the size of the RLC SDU, step 1125 is performed. Otherwise, if the size of the RLC PDU does not coincide with the size of the RLC SDU, step 1140 is performed. The fact that the size of the RLC PDU coincides with the size of the RLC SDU indicates that the size of the RLC PDU is larger than that of the RLC SDU by the UMD PDU header size. That is, this is a case in which the SI bit of the RLC PDU is set to 0, the LI representing the starting point and the end point of the RLC SDU is removed, and the data field of the RLC PDU including the RLC SDU is transmitted.

In step 1125, the RLC transmission side sets the SI bit to 0. In step 1130, the RLC transmission side removes the LI representing the starting point and the end point of the RLC SDU and inserts the RLC SDU into the data field of the RLC PDU. In step 1135, the RLC transmission side forwards the RLC PDU to the lower layer.

In step 1140, the RLC transmission side sets the SI bit to 1. In step 1145, the RLC transmission side frames an RLC SDU into an RLC PDU according to the existing scheme. That is, the RLC transmission side inserts the LI representing the starting point and the end point of the RLC SDU and inserts the RLC SDU into the data field of the RLC PDU. Herein, as the situation requires, the RLC transmission side may divide the RLC SDU into a plurality of RLC PDUs or concatenate the RLC SDU.

In step 1150, the RLC transmission side forwards the RLC PDU to the lower layer.

FIG. 12 is a flow diagram illustrating an operation of the MAC layer according to an embodiment of the present invention. Referring to FIG. 12, in step 1205, the MAC layer receives a report about the arrival of the RLC SDU and the size of the RLC SDU from the RLC layer. If a plurality of RLC SDUs have been received, the RLC layer also notifies the MAC layer of the number of the RLC SDUs. In step 1210, the MAC layer checks available transport block sizes from a transport channel connected to the RLC layer. The transport channel is a channel in which use data such as a packet size, a channel coding scheme, a channel coding rate, and an interleaving interval are processed. Various services are connected to a proper transport channel according to required quality of service.

In the transport channel, usable sizes of a packet are restricted. Herein, the packet transmitted through the transport channel will be referred to as a Transport Block (TB) and sizes of packets capable of being used in the transport channel will be referred to as a Transport Block size (TB size).

In step 1215, the MAC layer determines if a TB size corresponding to the RLC SDU size exists in the available TB sizes. When the TB size corresponding to the RLC SDU size exists, step 1220 is performed. Otherwise, when the TB size corresponding to the RLC SDU size does not exist, step 1225 is performed. The fact that the TB size corresponds to the RLC SDU size means that Equation (3) is satisfied.
TB size=MAC header size+UMD header size+RLC SDU size (3)

In Equation (3), the MAC header may exist in each transport channel and vice versa. Typically, the transport channel providing voice data does not include the MAC header. Accordingly, in Equation (3), the MAC header is zero and the UMD header size has a size of one byte or two bytes.

This means a case in which the RLC PDU size is larger than that of the RLC SDU by the UMD PDU header size. That is, this is a case in which the SI bit of the RLC PDU is set to 0, the LI representing the starting point and the end point of the RLC SDU is removed, and the data field of the RLC PDU including the RLC SDU is transmitted.

In step 1220, the MAC layer selects the TB size corresponding to the size of the RLC SDU and calculates an RLC PDU size corresponding to the selected TB size. The RLC PDU size has a value obtained by subtracting the MAC header size from the TB size.

In step 1230, the MAC layer informs the RLC layer of the RLC PDU size.

In step 1225, the MAC layer selects the smallest TB size from the TB sizes larger than the following required minimum TB size and determines an RLC PDU size corresponding to the selected TB size. Thereafter, step 1230 is performed, i.e., the MAC layer informs the RLC layer of the RLC PDU size.

Accordingly, the required minimum TB size is a sum of (a MAC header size+an RLC UMD header size+an LI size+an RLC SDU size). When the RLC SDU is framed into one RLC PDU, the LI size is set to two bytes. Otherwise, the LI size is set to one byte.

Because an RLC reception operation in the above-described embodiment of the present invention is identical to that in the first described embodiment of the present invention, the detailed description will be omitted.

According to the present invention, one bit information representing that an RLC SDU has the same size as that of an RLC PDU is used, such that it is unnecessary to insert multiple information representing a starting point/an end point/a padding of the RLC SDU. Therefore, it is possible to efficiently use restricted radio resources.

Although preferred embodiments of the present invention have been described for illustrative purposes, those skilled in the art will appreciate that various modifications, additions, and substitutions are possible, without departing from the scope and spirit of the present invention as disclosed in the accompanying claims, including the full scope of equivalents thereof.

1. A method for generating a Protocol Data Unit (PDU) by a Radio Link Control (RLC) layer using a Service Data Unit (SDU) received from an upper layer in a mobile communication system supporting a Voice over Internet Protocol (VoIP) service, the method comprising the steps of:
receiving the SDU from the upper layer;
determining, if a size of the received SDU is identical to a size of a data field of the PDU;
generating a header including information representing that the size of the SDU is identical to the size of the data field of the PDU when the size of the received SDU is identical to the size of the data field of the PDU; and
generating the PDU by allocating the SDU to the data field of the PDU.

2. The method as claimed in claim 1, the information identifies if the PDU includes a Length Indicator (LI) indicating a starting point of the SDU.

3. The method as claimed in claim 1, the information identifies if the PDU includes an LI indicating an end point of the SDU.

4. The method as claimed in claim 1, the information identifies if the PDU includes an LI indicating existence and absence of a padding of the SDU.

5. The method as claimed in claim 1, further comprising the step of:
framing the header by setting the information to 1, when the size of the SDU does not coincide with the size of the PDU,
wherein the header includes on one of an LI indicating a starting point of the SDU, an LI indicating an end point of the SDU, an LI indicating existence, and absence of a padding of the SDU.

6. The method as claimed in claim 1, further comprising the step of:
constructing the header by setting the information to 0, when the size of the SDU coincides with the size of the PDU,
wherein the header does not include an LI indicating a starting point of the SDU, an LI indicating an end point of the SDU, an LI indicating existence, and absence of a padding of the SDU.

7. The method as claimed in claim 1, wherein the information is allocated on behalf of a predetermined bit of a sequence number field indicating an order of the SDU.

8. The method as claimed in claim 1, wherein the information is allocated on behalf of a predetermined bit of error check bits assigned for determining if the data field of the PDU includes an error.

9. A method for extracting a Service Data Unit (SDU) by a Radio Link Control (RLC) layer of a reception side using a Protocol Data Unit (PDU) received from an RLC layer of a transmission side in a mobile communication system supporting a Voice over Internet Protocol (VoIP) service, the method comprising the steps of:
receiving the PDU from a lower layer;
checking information from a header of the PDU, the information representing that a size of a data field of the PDU is identical to a size of the SDU; and
extracting an entire data field of the PDU as the SDU when the information has been set to have an equal value.

10. The method as claimed in claim 9, wherein the RLC layer of the reception side extracts data of the PDU as the SDU when the information has not been set to have an equal value, the data being obtained by excluding the header, a Length Indicator (LI) indicating a starting point of the SDU, an LI indicating an end point of the SDU, and an LI indicating existence and absence of a padding of the SDU from the PDU.

11. A method for generating a Protocol Data Unit (PDU) by a Radio Link Control (RLC) layer using a Service Data Unit (SDU) received from an upper layer in a mobile communication system supporting a Voice over Internet Protocol (VoIP) service, the method comprising the steps of:
receiving, by the RLC layer, a dedicated SDU from the upper layer;
determining if a size of the received SDU is identical to a size of the dedicated SDU; and
allocating the SDU to a data field of the PDU when the size of the received SDU is identical to the size of the dedicated SDU when the size of the received SDU is identical to the size of the dedicated SDU.

12. A method for extracting a Protocol Data Unit (PDU) by a Radio Link Control (RLC) layer using a Service Data Unit (SDU) in a mobile communication system supporting a Voice over Internet Protocol (VoIP) service, the method comprising the steps of:
receiving, by the RLC layer, the SDU from an upper layer;
informing a lower layer of a size of a data field of a SDU and a number of SDUs
determining a size of a data field of a PDU and a number of PDUs by the lower layer;
determining if the size of the data field of the SDU received from the upper layer is identical to the size of the data field of the PDU from the lower layer; and
extracting an entire data field of the PDU as the SDU, when the size of the data field of the SDU is identical to the size of the data field of the PDU.

13. A method for generating a Protocol Data Unit (PDU) by a Radio Link Control (RLC) layer using a Service Data Unit (SDU) in a mobile communication system supporting a Voice over Internet Protocol (VoIP) service, the method comprising the steps of:
forwarding, by the RLC layer, the received SDU to a lower layer;
determining, by the lower layer, information representing a size of a packet available in a transport channel in consideration of the received SDU;
determining a PDU size according to the information;
determining, by the RLC layer, if a size of a data field of the PDU is identical to a size of the SDU in consideration of the determined PDU size;
framing a header including information representing that the size of the SDU is identical to the size of the data field of the PDU; and
generating the PDU by allocating the SDU to the data field of the PDU.

14. The method as claimed in claim 13, wherein the lower layer includes a Medium Access Control (MAC) layer, which determines an available transport block size in consideration of sizes and a number of received SDUs.

15. The method as claimed in claim 14, wherein the MAC layer determines the PDU size according to a transport block and notifies the RLC layer of the determined PDU size.
